(19) United States
(12) Patent Application Publication
(10) Pub. No.: US 2009/0053552 A1
(43) Pub. Date: Feb. 26, 2009

(54) CORROSION INHIBITOR

(76) Inventors: Berend-Jan De Gans, Muelheim a.d. Ruhr (DE); Rene Hansel, Dorsten (DE)

Correspondence Address: FROMMER LAWRENCE & HAUG, 745 FIFTH AVENUE- 10TH FL., NEW YORK, NY, 10151, US

(21) Appl. No.: 12/196,404

(22) Filed: Aug. 22, 2008

(30) Foreign Application Priority Data
Aug. 25, 2007 (DE) 102007040247.5

(51) Int. Cl. C23F 11/00; B32B 15/04

(52) U.S. Cl. 428/639; 106/14.42

(57) ABSTRACT

The invention relates to corrosion inhibitors of the general formula (I)

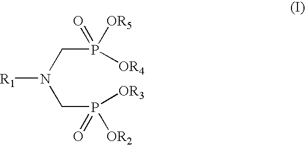

in which R₁ is a saturated, unsaturated or partly unsaturated, linear or branched hydrocarbon radical having 5 to 30 carbon atoms and OR₂ to OR₅ are identical or different and are OH or O⁻M⁺, M⁺ being an organic or inorganic cation, and the use thereof and compositions which comprise such corrosion inhibitors.

This application claims benefit under 35 U.S.C. 119(a) of German patent application DE 10 2007 040 247.5, filed on 25 Aug. 2007.

Any foregoing applications, including German patent application DE 10 2007 040 247.5, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to a corrosion inhibitor, in particular a corrosion inhibitor which prevents or reduces the corrosion of metals, such as, for example, iron, aluminium, zinc, magnesium or alloys thereof.

The protection of metals, such as, for example, iron, zinc, aluminium, magnesium or alloys thereof, which are in danger of corrosion is an important technical object. It arises in particular when the metal parts are not protected from corrosion by a permanent coating, such as, for example, a finish, owing to their processing state or owing to their field of use.

Typical examples of this are metal parts during industrial processing, such as, for example, during machining. In order to prevent or to suppress corrosion during or between the individual processing steps, the metal surfaces are brought into contact with corrosion inhibitors which form a temporary corrosion protection. For technical reasons, it is frequently necessary for the corrosion inhibitors to be capable of being brought into contact with the metal surfaces in the aqueous phase. This is the case, for example, when the corrosion inhibitor is to be used in cooling circulations. A desirable property of corrosion inhibitors is therefore to be water-soluble or at least water-dispersible.

The choice of a corrosion inhibitor depends on the metal which is to be protected from corrosion. For iron and steel, use of salts which are obtained by neutralizing a fatty acid, such as, for example, oleic acid, with an equivalent amount of an alkanolamine, such as, for example, monoethanolamine, has long been known in the prior art and is mentioned, for example, in U.S. Pat. No. 2,614,980. For aluminium, the use of organophosphonates as corrosion inhibitors is part of the prior art. Thus, Zimmerer in U.S. Pat. No. 3,351,558 describes the use of alkylphosphonates having 12 to 24 C atoms in the alkyl chain and alkylbenzenephosphonates having 9 to 18 C atoms in the alkyl chain as corrosion inhibitors for aluminium in cleaning agents. However, such compounds cannot be economically prepared which in practice has meant that they are scarcely used.

Many organophosphonates can be economically prepared by the reaction of (alkyl)amines with formaldehyde and phosphonic acid in the presence of an acidic catalyst. Examples are aminotris(methylenephosphonic acid) and hexamethylene-diaminetetra(methylenephosphonic acid), which are commercially available from Zschimmer & Schwarz Mohsdorf GmbH & Co KG as Cublen® AP and Cublen® D5012, respectively. Such compounds are used for inhibiting the precipitation of calcium carbonate and calcium sulphate in cooling water systems and detergents. Owing to a lack of effectiveness, such compounds are scarcely suitable as corrosion inhibitors for aluminium. Mitchell, in U.S. Pat. No. 3,723,347, describes the use of bismethylenephosphonic acids based on linear α,ω-modified alkyldiamines as corrosion inhibitors for aluminium, alkyldiamines having 2 to 8 C atoms being particularly preferred. However, it is to be expected that the corrosion inhibiting effect will be further improved with an increase in the number of C atoms in the alkyl chain. However, such compounds likewise cannot be economically prepared and are therefore scarcely available.

Hirozawa, Turcotte and Welch, in U.S. Pat. No. 5,230,819, describe the use of gem-diphosphonates as corrosion inhibitors for aluminium. However, these compounds exhibit very strong frothing. The stability in hard water is likewise problematic.

Hirozawa, Turcotte, Welch and Reynolds, in U.S. Pat. No. 5,419,845, describe the use of perfluorinated gem-diphosphonates as corrosion inhibitors for aluminium. However, the use of perfluorinated compounds is increasingly being called into question owing to the lack of biodegradability, so that industrial use of such compounds cannot be expected. Moreover, perfluorinated compounds likewise cannot be economically prepared.

Koch and Geke, in DE 199 59 588, describe mixtures of carboxylic acids, carboxamides, organophosphonic acids and amine compounds, but primarily as corrosion inhibitors for a metal treatment liquid for iron and steel having a pH in the range pH 5.5 to 8.5.

Christensen and Gelazis, in U.S. Pat. No. 4,406,811, describe mixtures which likewise contain a combination of a carboxylic acid and an organophosphonic acid. However, the organophosphonic acid solely serves the purpose of inhibiting the precipitation of calcium carbonate and calcium sulphate and not that of corrosion protection.

The use of organophosphonic acids as lubricants for aqueous rolling oils for steel has already been described in JP 09-048991. There is no indication in the document that the organophosphonic acids might be suitable as corrosion inhibitors.

An object of the present invention was therefore to provide alternative corrosion inhibitors which preferably do not have one or more of the disadvantages of the corrosion inhibitors known in the prior art and which do not have any environmentally hazardous fluorine and which are suitable for use in functional liquids.

Surprisingly, it has now been found that organophosphonic acids of the general formula (I)

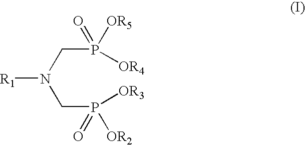

are outstandingly suitable as corrosion inhibitors, in particular for aluminium.

The present invention therefore relates to corrosion inhibitors of the general formula (I),

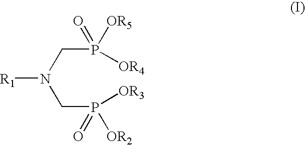

in which
R₁ is a saturated, unsaturated or partly unsaturated, linear or branched hydrocarbon radical having 5 to 30 carbon atoms and
OR₂ to OR₅ are identical or different and are OH or O⁻M⁺, M⁺ being an organic or inorganic cation, and the use of compounds of the general formula (I) as a corrosion inhibitor.

The present invention also relates to the use of corrosion inhibitors according to the invention in functional liquids which come into contact with aluminium, aluminium alloys, zinc, zinc alloys, magnesium, magnesium alloys, iron, steel, electroplated or galvanized steel or alloyed steels.

The present invention also relates to a preferably aqueous, corrosion-inhibiting composition for use with iron, steel, aluminium, magnesium, zinc or alloys or mixtures thereof, containing
a) one or more carboxylic acids,
b) one or more organic amines and/or alkanolamines and
c) one or more corrosion inhibitors according to the invention.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The corrosion inhibitors according to the invention have the advantage that they have no environmentally hazardous chlorine.

The flexibility which is demanded nowadays of a metal-processing industry has resulted in the same machines being used for machining iron, steel, aluminium and alloys thereof. A particular advantage of the corrosion inhibitor according to the invention is that, alone or mixed with other corrosion inhibitors, it has a good protective effect on all metals mentioned. There is therefore no necessity for changing the corrosion inhibitor or the functional liquid to which the corrosion inhibitor is added at the same time as changing the metal. It is also possible to protect metal parts, such as, for example, of machines, which consist of a plurality of metal varieties.

The corrosion inhibitors according to the invention and their use thereof are described below by way of example without it being intended to limit the invention to these exemplary embodiments. Where ranges, general formulae or classes of compounds are mentioned below, they are intended to comprise not only the corresponding ranges or groups of compounds which are explicitly mentioned but also all partial ranges and partial groups of compounds which can be obtained by excluding individual values (ranges) or compounds. Where documents are cited in the present description, the content thereof is intended to be fully part of the disclosure content of the present invention.

The corrosion inhibitor, according to the invention, of the general formula (I),

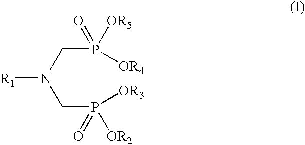

has, as a radical,
R₁ a saturated, unsaturated or partly unsaturated, linear or branched hydrocarbon radical having 5 to 30, preferably 6 to 24, carbon atoms, and the radicals
OR₂ to OR₅ are identical or different and are OH or O⁻M⁺, M⁺ being an organic or inorganic cation.

The radical R₁ is preferably an alkylbenzene radical having 0 to 20 carbon atoms in the alkyl chain. Alkylbenzene radicals having a saturated or partly unsaturated, linear or branched alkyl radical having 8 to 20 carbon atoms are particularly preferred.

The corrosion inhibitors according to formula I can be prepared by the reaction of a corresponding alkylamine with formaldehyde and phosphonic acid in the presence of an acidic catalyst. Acidic catalysts which may be used are, for example, organic or inorganic acids, such as, for example, hydrochloric acid or acidic solids.

The corrosion inhibitors according to the invention are preferably mixtures of compounds of the formula I in which the radicals R₁ are different saturated or unsaturated alkyl radicals having 6 to 24 carbon atoms. The corrosion inhibitors according to the invention are particularly preferably mixtures of compounds of the formula I in which the radicals R₁ are saturated and/or unsaturated alkyl radicals having a mode (main proportion) of the distribution of the number of carbon atoms in the radical R₁ of 8 to 22, preferably of 10 to 20 and preferably of 12 to 18. Such mixtures are obtained by using so-called fatty amines as raw materials in the preparation. The nomenclature fatty amine arises from the preparation of the fatty amines on the basis of natural fats and oils. Examples of such fats are cocoa butter, coconut oil, cottonseed oil, peanut oil, hazelnut oil, linseed oil, thistle oil, soya oil, sunflower oil, grapeseed oil, maize germ oil, almond oil, olive oil, palm oil, rapeseed oil, walnut oil or wheatgerm oil. The corrosion inhibitors according to the invention are preferably mixtures of compounds of the formula I in which the radicals R₁ are based on fatty amines of coconut oil. The corrosion inhibitors according to the invention are preferably mixtures of compounds of the formula I in which the radicals R₁ are different saturated or unsaturated alkyl radicals having 6 to 20 carbon atoms, the molar ratio of the alkyl radicals being dependent on the natural coconut oil used in the preparation of the fatty amine employed.

The corrosion inhibitors according to the invention preferably comprise exclusively compounds of the formula I in which not all radicals OR₂ to OR₅ are OH radicals. Preferably, more than half the radicals OR₂ to OR₅, particularly preferably all radicals OR₂ to OR₅, are O⁻M⁺ radicals. The corrosion inhibitors according to the invention are preferably compounds of the formula I in which M⁺ is an alkali metal ion, an ammonium ion and/or an organic substituted ammonium ion. Sodium and potassium are preferred as the alkali metal. As the organically substituted ammonium ion, the compounds of the formula I may have tetramethylammonium, tetra-n-propylammonium, tetra-n-butylammonium, monoethanolammonium, diethanol-ammonium, triethanolammonium, N,N-dimethylethanolammonium, N,N-diethylethanolammonium, N-methyldiethanolammonium, N-methylethanolammonium, monoisopropanolammonium, diiso-propanolammonium, triisopropanolammonium, N-isopropyl-ethanolammonium, 3-dimethylaminopropylammonium, 2-ammonium-2-methylpropanol (AMP 75), 2-ammonium-1-butanol, 2-ammonium-2-methyl-1,3-propanediol, diglycolammonium, 2-ammonium-2-ethyl-1,3-propanediol, tris(hydroxymethyl)-ammoniummethane, N,N-diethylhydroxylammonium, 3-ammonium-propanol, monomethylammonium, dimethylammonium, trimethyl-ammonium, monoethylammonium, diethylammonium, triethyl-ammonium, mono-n-propylammonium, di-n-propylammonium, tri-n-propylammonium, monoisopropylammonium, diisopropyl-ammonium, ethyldiisopropylammonium, mono-n-butylammonium, di-n-butylammonium, tri-n-butylammonium, monocyclohexane-ammonium, dicyclohexaneammonium, mono-2-ethylhexylammonium, bis-2-ethylhexylammonium, ethylenediammonium, diethylene-triammonium, triethylenetetraammonium, tetraethylenepenta-ammonium, pentaethylenehexaammonium, hexaethylenehepta-ammonium, morpholinium, N-methylmorpholinium, N-ethyl-morpholinium, ammoniumethylpiperazines, diglycolammonium and/or 2-(2-ammoniumethyl)aminoethanol as M⁺. Preferably at least one M⁺ is a diglycolammonium ion, preferably all M⁺ in the compounds of the formula (I) are diglycolammonium ions.

Particularly preferred corrosion inhibitors are coconut aminebis(methylenephosphonic acid) or salts thereof, preferably ammonium and/or diglycolammonium salts thereof.

The corrosion inhibitors according to the invention or compounds of the formula I can be used as corrosion inhibitors in concentrates or compositions for inhibiting corrosion.

The corrosion inhibitors according to the invention can preferably be used in functional liquids, preferably aqueous functional liquids, which come into contact with metals. In the context of the present invention, functional liquids are understood as meaning liquids which come into contact with metals and perform functions such as, for example, the removal of heat and/or lubrication. Such functional liquids are in particular drilling and cutting fluids, cooling liquids and cooling lubricants. Particularly preferred functional liquids are those which are used in cutting processes.

The corrosion inhibitors according to the invention are used in functional liquids which come into contact with a metal.

For the purposes of this invention, the transition metals which are coated with the corrosion inhibitor of the invention are intended to encompass elements which have partly filled d or f shells as well as elements that have partly filled d or f shells in any of their commonly occurring oxidation states. The transition elements can be subdivided into three main groups: (a) the main transition elements or d-block elements, (b) the lanthanide elements, and (c) the actinide elements and would include elements 21-30; 39-48; 57-71 and 89-112.

The metals coated with the corrosion inhibitor of the invention also include the metals of Group IA, Group IIA, Group IIIA, Group IVA, Group VA and Group VIA. (Group notations are the notations recognized by the Chemical Abstracts Service (CAS)).

The metals coated with the corrosion inhibitor of the invention are also intended to encompass alloys of the above described metals.

The corrosion inhibitors according to the invention are preferably used in functional liquids which come into contact with aluminium or aluminium alloys.

However, the corrosion inhibitors according to the invention can also be used in functional liquids which come into contact with zinc, magnesium, iron, zinc alloys, magnesium alloys or iron alloys. In the case of steel, the functional liquids are preferably not understood as meaning cold-rolling oils. In the context of the present invention, functional liquids are therefore preferably not understood as meaning rolling oils for use with steel and particularly preferably not rolling oils for use with metals or alloys.

The functional liquids may have different compositions. They may be present as concentrate or as a ready-to-use mixture. The ready-to-use functional liquid can be obtained from the concentrate by simple addition of the desired amount of water.

Preferred functional liquids, in particular ready-to-use functional liquids, contain water and from 0.005 to <5% by weight of corrosion inhibitors according to the invention.

Particularly preferably, the functional liquids or concentrates thereof are preferably aqueous, corrosion-inhibiting compositions according to the invention for use with iron, steel, aluminium, magnesium or zinc or alloys or mixtures thereof, preferably aluminium or aluminium alloys, containing
a) one or more carboxylic acids,
b) one or more organic amines and/or alkanolamines, in particular alkanolamines,
c) at least one corrosion inhibitor, according to the invention, of formula I.

It may be advantageous if the composition according to the invention contains one or more ethoxylated or non-ethoxylated carboxamides as further component d) in addition to the components a), b) and c).

Preferred functional liquids, such as, for example, cooling lubricant concentrates, are commonly referred to as soluble oils (proportion of mineral oil>40%) or as semisynthetic fluids (proportion of mineral oil<40%). The mineral oil content can be wholly or partly replaced by synthetic or vegetable ester oils. Other components may be, for example, ionic or nonionic emulsifiers or mixtures of the two.

Such functional liquids preferably contain:
oil components, preferably from 15 to 65 parts by mass,
emulsifiers, preferably from 15 to 35 parts by mass,
corrosion inhibitors not according to the invention, preferably from 5 to 25 parts by mass,
cosolvent, preferably from 1 to 10 parts by mass,
corrosion-inhibiting composition according to the invention, preferably from 5 to 25 parts by mass,
antifoam, preferably from 0.05 to 1 part by mass,
biologically active components, in particular biocides or fungicides, and
optionally water.

The functional liquids may contain, for example, naphthenic oil or liquid paraffin as oil components.

For example, nonionic emulsifiers, tall oil fatty acid or petroleum sulphate may be present as emulsifiers.

For example, alkanolamines or boric acid amines may be present as corrosion inhibitors not according to the invention.

For example, butyldiglycol or polyglycol ether may be present as cosolvents.

Antifoams present may be the antifoams used in the prior art, in particular those based on polysiloxanes.

For example, a boric acid amine mixture may be present as biologically active components in the functional liquid according to the invention.

Two typical formulations (concentrates) are given below.

### Soluble Oil Formulation:

45% by mass of naphthenic oil,
25.7% by mass of emulsifier packet (nonionic emulsifier, tall oil fatty acid, petroleum sulphonate),
15% by mass of alkanolamines,
4.2% by mass butyldiglycol,
10% by mass of corrosion-inhibiting composition according to the invention,
0.1% by mass of antifoam.

### Semisynthetic Formulation:

20% by mass of liquid paraffin,
10% by mass of corrosion-inhibiting composition according to the invention,
10% by mass of polyglycol ether,
20% by mass of boric acid amine mixture,
19% by mass of water,
11% by mass of tall oil fatty acid.

These merely fundamental formulations may also contain other components, such as biocides, fungicides and metal deactivators.

The concentration of the corrosion-inhibiting composition according to the invention in the concentrate of the functional liquid is preferably from 5 to 15% by mass. The concentrates are preferably diluted with water until the concentration of the concentrate in the ready-to-use mixture is not more than up to about 5 to 10% by mass. The concentration of the corrosion-inhibiting composition in the ready-to-use mixture (functional liquid) is preferably from 0.1 to 2% by mass, particularly preferably between 0.2 and 0.7% by mass.

The mass ratio of components a), b) and optionally d) to component c) in the composition according to the invention is preferably from 5:1 to 50:1, preferably from 8:1 to 30:1 and particularly preferably from 10:1 to 20:1.

If the composition according to the invention contains the component d), it preferably comprises it in a proportion of 2 to 98% by weight, preferably 40 to 80% by weight, based on the sum of the components a) to d).

The carboxylic acid of component a) may be selected, for example, from mono- or polybasic, saturated or unsaturated, linear or branched aliphatic carboxylic acids having 5 to 30 C atoms and from carboxylic acids having heteroatoms inserted into the carbon chain, which have between 5 and 40 atoms in the carbon-heteroatom chain. Examples of suitable carboxylic acids are the straight-chain saturated carboxylic acids n-dodecanoic acid, n-tetradecanoic acid, n-hexadecanoic acid and n-octadecanoic acid. An example of a dicarboxylic acid is 1,12-dodecanedicarboxylic acid. The carboxylic acids are preferably mixtures of mono- or polybasic, saturated or unsaturated, linear or branched aliphatic carboxylic acids having 5 to 30 C atoms and of carboxylic acids having heteroatoms inserted into the carbon chain, which have between 5 and 40 atoms in the carbon-heteroatom chain. Preferred carboxylic acids (optionally with inserted heteroatoms) are those in which the saturated and/or unsaturated alkyl radicals may have a mode (main proportion) of the distribution of the number of carbon atoms in the alkyl radical of 5 to 30, preferably 8 to 24 and particularly preferably 10 to 20 carbon atoms. For example, ether carboxylic acids of the general formula R—(O—C₂H₄)ₙ—OCH₂COOH, in which R represents a linear or branched, saturated or unsaturated alkyl radical having 6 to 24 C atoms and n represents a number in the range from 1 to 12, can be used as carboxylic acids having heteroatoms inserted into the carbon chain. The ether carboxylic acids may be industrial mixtures of molecules having different radicals R and different values for n. An example of this is the industrial laurylether carboxylic acid in which R represents a mixture of linear, saturated alkyl groups having 12 and 14 C atoms and n is about 2.5.

Tall oil fatty acid, colza oil fatty acid, castor oil fatty acid or oleic acid or mixtures thereof are particularly preferably used as carboxylic acids (component a)).

For example, monoethanolamine, diethanolamine, triethanol-amine, N,N-dimethylethanolamine, N,N-diethylethanolamine, N-methyldiethanolamine, N-methylethanolamine, monoiso-propanolamine, diisopropanolamine, triisopropanolamine, N-isopropylethanolamine, 3-dimethylaminopropylamine, 2-amino-2-methylpropanol, 2-amino-1-butanol, 2-amino-2-methyl-1,3-propanediol, diglycolamine, 2-amino-2-ethyl-1,3-propanediol, tris(hydroxymethyl)aminomethane, N,N-di-ethylhydroxylamine, 3-aminopropanol, monomethylamine, dimethylamine, trimethylamine, monoethylamine, diethyl-amine, triethylamine, mono-n-propylamine, di-n-propylamine, tri-n-propylamine, monoisopropylamine, diisopropylamine, ethyldiisopropylamine, mono-n-butylamine, di-n-butylamine, tri-n-butylamine, monocyclohexaneamine, dicyclohexaneamine, mono-2-ethylhexylamine, bis-2-ethylhexylamine, ethylene-diamine, diethylenetriamine, triethylenetetraamine, tetra-ethylenepentaamine, pentaethylenehexaamine, hexaethylene-heptaamine, morpholines, N-methylmorpholines, N-ethyl-morpholines, aminoethylpiperazines, 2-(2-aminoethyl)amino-ethanol, preferably monoethanolamine, diethanolamine, tri-ethanolamine, diglycolamine, monoisopropanolamine, di-glycolamine or 2-amino-2-methylpropanol, can be used as organic amine and/or alkanolamine (component b)). Diglycolamine is preferably used as the organic amine. The organic amines or alkanolamines may increase the corrosion protection effect and, with a suitable choice, additionally have a buffer effect so that they help to keep the pH of the composition in a predetermined range.

Coconut aminebis(methylenephosphonic acid) or salts thereof, preferably their ammonium salt and/or diglycolammonium salt thereof, are preferably used as component c).

Preferably, carboxamides of carboxylic acids selected from mono- or polybasic, saturated or unsaturated, linear or branched aliphatic carboxylic acids having 5 to 30 C atoms are used as component d). Preferably, ethoxylated carboxamides are used as component d). The amidation can preferably take place with monoethanolamine or diglycolamine. The degree of ethoxylation may vary between 0 and 10.

### BRIEF DESCRIPTION OF THE DRAWINGS

FIG. 1 shows the impedance spectra measured in Example 1, as Bode diagrams.

FIG. 2 shows the impedance spectra measured in Example 2 on structural steel St37, likewise as a Bode diagram.

FIG. 3 shows the impedance spectra measured in Example 2 on aluminium 7075.

FIG. 4 shows an image of 2 aluminium 7075 test plates after 7 days.

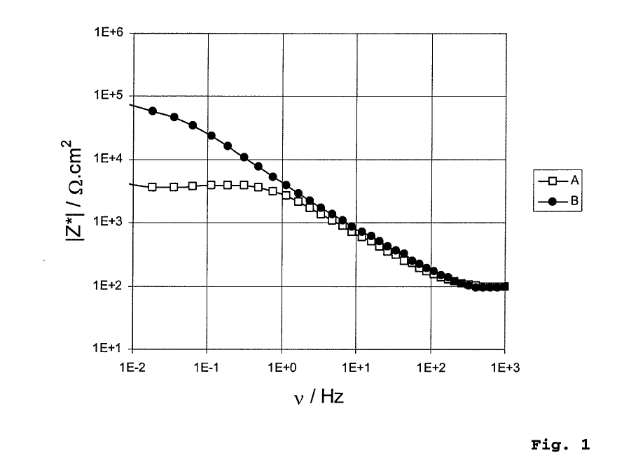

The invention is explained in more detail with reference to FIGS. 1 to 4 without it being intended to limit the invention thereto.

FIG. 1 shows the impedance spectra measured in Example 1, as Bode diagrams. The frequency ν is plotted logarithmically along the X axis. The absolute value of the impedance |Z*| is plotted logarithmically along the Y axis. The measured values obtained with the use of the triethanolammonium salt of hexamethylenetetra(methylene-phosphonic acid) on aluminium 995 are characterized by an “A” and shown as squares. The measured values obtained with the use of the triethanolammonium salt of coconut aminebis(methylenephosphonic acid) are characterized by “B” and shown as circles.

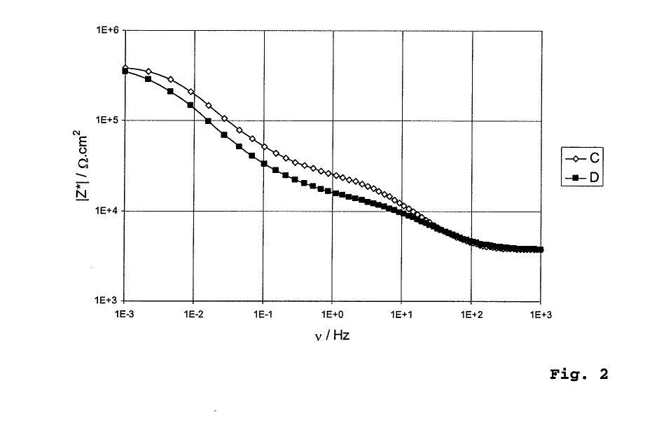

FIG. 2 shows the impedance spectra measured in Example 2 on structural steel St37, likewise as a Bode diagram. The measured values characterized by “C” and shown as circles were obtained with the use of an aqueous solution containing 1.50% by weight of a mixture of tall oil fatty acid, monoethanolamine and the ammonium salt of coconut aminebis(methylenephosphonic acid) as a corrosion inhibitor. The measured values characterized by “D” and shown as squares were obtained with the use of an aqueous solution containing 1.50% by weight of a mixture of tall oil fatty acid and monoethanolamine as a corrosion inhibitor.

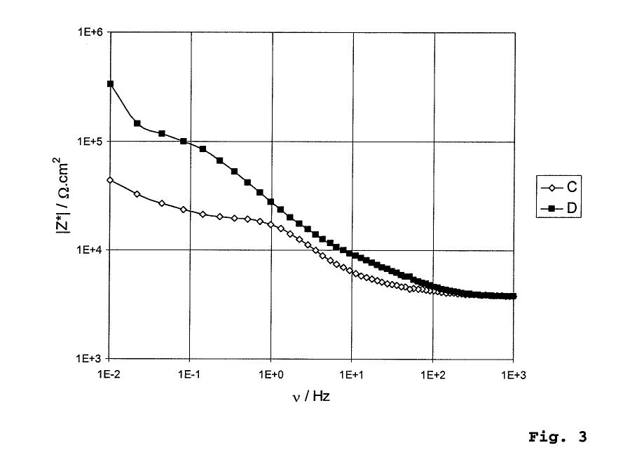

FIG. 3 shows the impedance spectra measured in Example 2 on aluminium 7075. The measured values characterized by “C” and shown as circles were obtained with the use of an aqueous solution containing 1.50% by weight of a mixture of tall oil fatty acid, monoethanolamine and the ammonium salt of coconut aminebis(methylenephosphonic acid) as a corrosion inhibitor. The measured values characterized by “D” and shown as squares were obtained with the use of an aqueous solution containing 1.50% by weight of a mixture of tall oil fatty acid and monoethanolamine as a corrosion inhibitor.

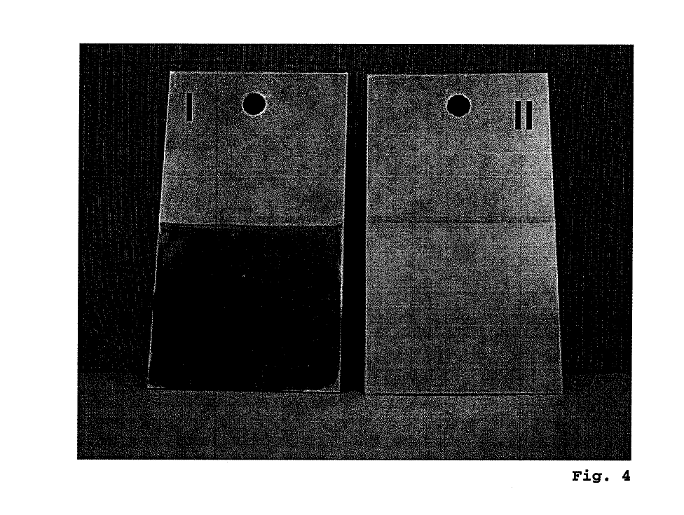

FIG. 4 shows an image of 2 aluminium 7075 test plates after 7 days. The plate characterized by “I” was tested in the formulation without corrosion inhibitor according to the invention. The plate is strongly corroded where it was in contact with the formulation. The plate characterized by “II” was tested in the formulation with corrosion inhibitor according to the invention. Corrosion is scarcely visible after 7 days.

In the examples shown below, the present invention is described by way of example without it being intended to limit the invention, the field of use of which is evident from the entire description and the claims, to the embodiments mentioned in the examples.

### EXAMPLES

### Impedance Measurements:

The impedance measurements were carried out with an IM6 impedance spectroscope from Zahner (Kronach, Germany) using the Thales V3.10 software (likewise from Zahner) for control and evaluation of the data. The glass measuring cell had a volume of 1 1 and was provided at the bottom with an opening having a diameter of 35 mm. The measurement is effected potentiometrically with a 3-electrode configuration. A silver-silver chloride electrode from Schott was used as the reference electrode. A platinum wire serves as a counterelectrode, and either sheet-like aluminium 995 (according to DIN 1712), aluminium 7075 (according to DIN 1725) or structural steel St37 (according to DIN 17100) as a working electrode. The small plates used as working electrodes have a size of 6×6 cm and are pretreated by grinding by means of an ATM Sapphire 320 grinding disc. During the grinding, coating was effected with water. The small plates were ground successively with abrasive papers of grades 320, 600 and 1200. For cleaning to remove organic residues and metal particles, the small plates were immersed in a beaker containing isopropanol. The beaker was then placed for 10 minutes in an ultrasonic bath. After removal of the small plates from the isopropanol, they were dried with compressed air.

Solutions which contained corrosion inhibitor were prepared in a closed glass vessel and likewise placed in an ultrasonic bath for 10 minutes. Unless stated otherwise, tap water (Essen, Germany) of 7.8°DH was used.

For each measurement, a waiting time of 30 minutes was allowed to enable the equilibrium to become established in the system investigated. Measurement was effected with an amplitude of 5 mV in the range from 0.01 to 1000 Hz (aluminium) of from 0.001 to 1000 Hz (steel). During the measurement, air was passed continuously through the measuring cell in order to ensure a constant oxygen concentration. The measurement was carried out at room temperature.

### Data Processing:

The measured impedance spectra were plotted as Bode diagrams. The frequency ν is plotted logarithmically along the X axis. The impedance |Z*| is plotted logarithmically along the Y axis.

The performance of the corrosion inhibitors was assessed as follows. The difference between the impedance at low and at high frequencies—provided that both have reached a plateau value—gives a resistance which is referred to as polarization resistance. The polarization resistance is inversely proportional to the corrosion current. The greater the polarization resistance, the less the corrosion. In the case of aluminium, the polarization resistance determined in this manner contains a contribution from the aluminium oxide layer on the aluminium surface. Above pH 9.0, this contribution is, however, negligible.

### Example 1

FIG. 1 shows a Bode diagram of aqueous solutions containing 1.50% by weight of the triethanolammonium salt of hexa-methylenetetra(methylenephosphonic acid) (“A”) or 1.50% by weight of the triethanolammonium salt of coconut aminebis-(methylenephosphonic acid) (“B”). The pH of these solutions was adjusted to pH 9.25 with concentrated ammonia. The impedance spectra were measured with aluminium 995 as the working electrode.

From FIG. 1, it is evident that the coconut aminebis-(methylenephosphonic acid) salt has a much better protective effect on aluminium than the hexamethylenetetra-(methylenephosphonic acid) salt. On the basis of the spectrum of coconut aminebis(methylenephosphonic acid) salt, a polarization resistance of 9×10⁵ Ω·cm² can be estimated. For the hexamethylenetetra(methylenephosphonic acid) salt, 5×10⁴ Ω·cm² is found, only a twentieth of that which is achieved with the coconut aminebis(methylene-phosphonic acid) salt.

### Example 2

An aqueous solution containing 1.50% by weight of a mixture of the following substances: 76 parts by mass of tall oil fatty acid, 19 parts of monoethanolamine and 5 parts of ammonium salt of coconut aminebis(methylenephosphonic acid) was prepared (“C”). In addition, an aqueous solution containing 1.50% by weight of a mixture of 80 parts by mass of tall oil fatty acid and 20 parts of monoethanolamine was prepared (“D”). The pH of these solutions was adjusted to a pH of 9.0 with monoethanolamine. The impedance spectra were measured both on aluminium 7075 and on structural steel St37.

As is evident from the Bode diagrams in FIGS. 2 and 3, the protective effect on steel is virtually identical for both mixtures. The spectra—regardless of which diagram—virtually coincide. However, the spectra on aluminium 7075 show large differences. |Z*| of the mixture of tall oil fatty acid and monoethanolamine (“D”) shows an increase between 10 and 1 Hz. This increase is presumably due to a residual aluminium oxide which ensures passivation of the surface at low pH. The addition of ammonium salt of coconut aminebis(methylenephosphonic acid) ensures a sharp increase of |Z*| in the frequency range below 1 Hz. This means that, even in low concentration, the ammonium salt of coconut aminebis(methylenephosphonic acid) produces a much better protective effect on aluminium than the components present in mixture D.

### Example 3

### Immersion Test

The immersion tests were carried out with sheet-like aluminium 7075 at room temperature in closed glass containers having screw caps. The sheets were first wet-ground with abrasive paper of grade 400 by hand. Thereafter, the sheets were half-immersed in liquid. The following formulation (formulation II) was used (data in parts by mass):
45.0 parts of naphthenic oil (Nynast 25T22),
17.5 parts of oleyl/cetyl ethoxylate (Emulsogen M),
8.2 parts of tall oil fatty acid,
15.0 parts of triethanolamine,
4.2 parts of butyldiglycol,
10.0 parts of corrosion-inhibiting composition according to the invention, consisting of 47.5% by weight of oleic acid, 47.5% by weight of monoethanolamine and 5% by weight of corrosion inhibitor according to the invention [ammonium salt of coconut aminebis-(methylenephosphonic acid)],
0.1 part of antifoam (Tego Antifoam 793).

The same formulation, but without corrosion inhibitor according to the invention (10 parts of a composition which consists of 50% by weight of oleic acid and 50% by weight of monoethanolamine were used), was also tested as a comparison (formulation I).

FIG. 4 shows an image of the 2 test sheets after 7 days. While strong corrosion was observable on the sheet marked with “I” which was immersed in a formulation without corrosion inhibitor, scarcely any traces of corrosion were visible on the sheet marked with “II” which was immersed in the formulation with the corrosion inhibitor according to the invention.

Having thus described in detail various embodiments of the present invention, it is to be understood that many apparent variations thereof are possible without departing from the spirit or scope of the present invention.

1. A metal composition which comprises of a metal coated with a corrosion inhibitor of the general formula (I), 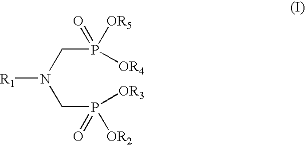
in which
R₁ is a saturated, unsaturated or partly unsaturated, linear or branched hydrocarbon radical having 5 to 30 carbon atoms and
OR₂ to OR₅ are identical or different and are OH or O⁻M⁺, M⁺ being an organic or inorganic cation.

2. The metal composition of claim 1, wherein the radical R₁ is an alkylbenzene radical having 0 to 20 carbon atoms in the alkyl chain or a saturated or partly unsaturated, linear or branched alkyl radical having 8 to 20 carbon atoms.

3. The metal composition of claim 1, wherein M⁺ is an alkali metal ion, ammonium ion or organically substituted ammonium ion.

4. The metal composition of claim 1, wherein M⁺ is a tetramethylammonium, tetra-n-propylammonium, tetra-n-butylammonium, monoethanolammonium, diethanolammonium, triethanolammonium, N,N-dimethylethanolammonium, N,N-diethylethanolammonium, N-methyldiethanolammonium, N-methylethanolammonium, monoisopropanolammonium, diiso-propanolammonium, triisopropanolammonium, N-isopropyl-ethanolammonium, 3-dimethylaminopropylammonium, 2-ammonium-2-methylpropanol, 2-ammonium-1-butanol, 2-ammonium-2-methyl-1,3-propanediol, diglycolammonium, 2-ammonium-2-ethyl-1,3-propanediol, tris(hydroxymethyl)-ammoniummethane, N,N-diethylhydroxylammonium, 3-ammoniumpropanol, monomethylammonium, dimethyl-ammonium, trimethylammonium, monoethylammonium, di-ethylammonium, triethylammonium, mono-n-propylammonium, di-n-propylammonium, tri-n-propylammonium, monoisopropylammonium, diisopropylammonium, ethyldi-isopropylammonium, mono-n-butylammonium, di-n-butyl-ammonium, tri-n-butylammonium, monocyclohexaneammonium, dicyclohexaneammonium, mono-2-ethylhexylammonium, bis-2-ethylhexylammonium, ethylenediammonium, diethylene-triammonium, triethylenetetraammonium, tetraethylenepentaammonium, pentaethylenehexaammonium, hexaethyleneheptaammonium, morpholinium, N-methylmorpholinium, N-ethylmorpholinium, ammoniumethylpiperazine, diglycolammonium and/or 2-(2-ammoniumethyl)aminoethanol ion.

5. The metal composition of claim 2, wherein M⁺ is a tetramethylammonium, tetra-n-propylammonium, tetra-n-butylammonium, monoethanolammonium, diethanolammonium, triethanolammonium, N,N-dimethylethanolammonium, N,N-diethylethanolammonium, N-methyldiethanolammonium, N-methylethanolammonium, monoisopropanolammonium, diiso-propanolammonium, triisopropanolammonium, N-isopropyl-ethanolammonium, 3-dimethylaminopropylammonium, 2-ammonium-2-methylpropanol, 2-ammonium-1-butanol, 2-ammonium-2-methyl-1,3-propanediol, diglycolammonium, 2-ammonium-2-ethyl-1,3-propanediol, tris(hydroxymethyl)-ammoniummethane, N,N-diethylhydroxylammonium, 3-ammoniumpropanol, monomethylammonium, dimethyl-ammonium, trimethylammonium, monoethylammonium, di-ethylammonium, triethylammonium, mono-n-propylammonium, di-n-propylammonium, tri-n-propylammonium, monoisopropylammonium, diisopropylammonium, ethyldi-isopropylammonium, mono-n-butylammonium, di-n-butyl-ammonium, tri-n-butylammonium, monocyclohexaneammonium, dicyclohexaneammonium, mono-2-ethylhexylammonium, bis-2-ethylhexylammonium, ethylenediammonium, diethylene-triammonium, triethylenetetraammonium, tetraethylenepentaammonium, pentaethylenehexaammonium, hexaethyleneheptaammonium, morpholinium, N-methylmorpholinium, N-ethylmorpholinium, ammoniumethylpiperazine, diglycolammonium and/or 2-(2-ammoniumethyl)aminoethanol ion

6. The metal composition of claim 5, wherein the metal is a metal selected from the group consisting of metals of Group IA, Group IIA, Group IIIA, Group IVA, Group VA, Group VIA, transition metals and alloys thereof.

7. The metal composition of claim 6, wherein the metal is selected from the group consisting of zinc, zinc alloys, magnesium, magnesium alloys, iron, steel, electroplated or galvanized steel and alloyed steels.

8. The metal composition of claim 7, wherein the metal is aluminum or aluminum alloys.

9. A method of inhibiting corrosion in a metal which comprises of coating a metal with a corrosion inhibitor of the general formula (I), 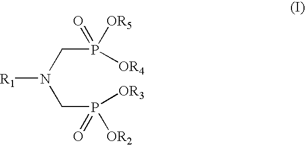
in which
R₁ is a saturated, unsaturated or partly unsaturated, linear or branched hydrocarbon radical having 5 to 30 carbon atoms and
OR₂ to OR₅ are identical or different and are OH or O⁻M⁺, M⁺ being an organic or inorganic cation.

10. The method of claim 9, wherein the radical R₁ is an alkylbenzene radical having 0 to 20 carbon atoms in the alkyl chain or a saturated or partly unsaturated, linear or branched alkyl radical having 8 to 20 carbon atoms.

11. The method of claim 9, wherein M⁺ is an alkali metal ion, ammonium ion or organically substituted ammonium ion.

12. The method of claim 9, wherein M⁺ is a tetramethylammonium, tetra-n-propylammonium, tetra-n-butylammonium, monoethanolammonium, diethanolammonium, triethanolammonium, N,N-dimethylethanolammonium, N,N-diethylethanolammonium, N-methyldiethanolammonium, N-methylethanolammonium, monoisopropanolammonium, diiso-propanolammonium, triisopropanolammonium, N-isopropyl-ethanolammonium, 3-dimethylaminopropylammonium, 2-ammonium-2-methylpropanol, 2-ammonium-1-butanol, 2-ammonium-2-methyl-1,3-propanediol, diglycolammonium, 2-ammonium-2-ethyl-1,3-propanediol, tris(hydroxymethyl)-ammoniummethane, N,N-diethylhydroxylammonium, 3-ammoniumpropanol, monomethylammonium, dimethyl-ammonium, trimethylammonium, monoethylammonium, di-ethylammonium, triethylammonium, mono-n-propylammonium, di-n-propylammonium, tri-n-propylammonium, monoisopropylammonium, diisopropylammonium, ethyldi-isopropylammonium, mono-n-butylammonium, di-n-butyl-ammonium, tri-n-butylammonium, monocyclohexaneammonium, dicyclohexaneammonium, mono-2-ethylhexylammonium, bis-2-ethylhexylammonium, ethylenediammonium, diethylene-triammonium, triethylenetetraammonium, tetraethylenepentaammonium, pentaethylenehexaammonium, hexaethyleneheptaammonium, morpholinium, N-methylmorpholinium, N-ethylmorpholinium, ammoniumethylpiperazine, diglycolammonium and/or 2-(2-ammoniumethyl)aminoethanol ion.

13. The method of claim 10, wherein M⁺ is a tetramethylammonium, tetra-n-propylammonium, tetra-n-butylammonium, monoethanolammonium, diethanolammonium, triethanolammonium, N,N-dimethylethanolammonium, N,N-diethylethanolammonium, N-methyldiethanolammonium, N-methylethanolammonium, monoisopropanolammonium, diiso-propanolammonium, triisopropanolammonium, N-isopropyl-ethanolammonium, 3-dimethylaminopropylammonium, 2-ammonium-2-methylpropanol, 2-ammonium-1-butanol, 2-ammonium-2-methyl-1,3-propanediol, diglycolammonium, 2-ammonium-2-ethyl-1,3-propanediol, tris(hydroxymethyl)-ammoniummethane, N,N-diethylhydroxylammonium, 3-ammoniumpropanol, monomethylammonium, dimethyl-ammonium, trimethylammonium, monoethylammonium, di-ethylammonium, triethylammonium, mono-n-propylammonium, di-n-propylammonium, tri-n-propylammonium, monoisopropylammonium, diisopropylammonium, ethyldi-isopropylammonium, mono-n-butylammonium, di-n-butyl-ammonium, tri-n-butylammonium, monocyclohexaneammonium, dicyclohexaneammonium, mono-2-ethylhexylammonium, bis-2-ethylhexylammonium, ethylenediammonium, diethylene-triammonium, triethylenetetraammonium, tetraethylenepentaammonium, pentaethylenehexaammonium, hexaethyleneheptaammonium, morpholinium, N-methylmorpholinium, N-ethylmorpholinium, ammoniumethylpiperazine, diglycolammonium and/or 2-(2-ammoniumethyl)aminoethanol ion.

14. The method of claim 13, wherein the metal is a metal selected from the group consisting of metals of Group IA, Group IIA, Group IIIA, Group IVA, Group VA, Group VIA, transition metals and alloys thereof.

15. The method of claim 14, wherein the metal is selected from the group consisting of zinc, zinc alloys, magnesium, magnesium alloys, iron, steel, electroplated or galvanized steel and alloyed steels.

16. The method of claim 15, wherein the metal is aluminum or aluminum alloys.

17. A corrosion-inhibiting composition for use with iron, steel, aluminium, magnesium or zinc or alloys or mixtures thereof, containing
one or more carboxylic acids,
one or more organic amines and/or alkanolamines and
one or more compounds according of the general formula 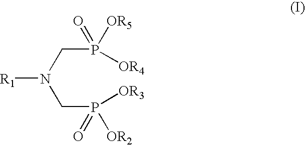
in which
R₁ is a saturated, unsaturated or partly unsaturated, linear or branched hydrocarbon radical having 5 to 30 carbon atoms and
OR₂ to OR₅ are identical or different and are OH or O⁻M⁺, M⁺ being an organic or inorganic cation.

18. The composition according to claim 17, characterized in that it further contains as component
d) one or more ethoxylated or non-ethoxylated carboxamides.

19. The composition according to claim 1 wherein the amount of the compound of general formula (I) ranges from 0.005 to <5% by weight and the pH of the composition is from about 8.5 to about 13.0.

20. The composition according to claim 1, wherein pH of the composition is from about 9.0 to about 9.5.
